(19) United States
(12) Patent Application Publication
(10) Pub. No.: US 2018/0330629 A1
(43) Pub. Date: Nov. 15, 2018

(54) Preparation Assessment System and Method Thereof

(71) Applicant: Seshat Technologies, Mumbai (IN)

(72) Inventors: Anuragi Raman, Mumbai (IN); Kamaldeep Singh Bhatia, Mumbai (IN); Suryaganesh Sastry, Mumbai (IN)

(21) Appl. No.: 15/773,890

(22) PCT Filed: Nov. 5, 2016
(86) PCT No.: PCT/IN2016/050387

§ 371 Date: May 4, 2018

(30) Foreign Application Priority Data
Jun. 11, 2015 (IN) 4242/MUM/2015

(51) Int. Cl. G09B 7/04; G09B 5/02; G06F 17/30; G09B 3/02

(52) U.S. Cl. CPC G09B 7/04; G09B 5/02; G06Q 50/20; G06F 17/30126; G09B 3/02; G06F 17/30144

(57) ABSTRACT

The present invention provides a preparation assessment system for competitive and non-competitive exams, the system comprising an interface unit configured to receive an input data from a participant, the input data includes answer for a question, a server for storing the input data received from the participant and a pre-determined data, a processor for processing the input data received from the participant and corresponding pre-determined data to generate an optimum result to be displayed on the interface unit in a graphical format, the processor configured to capture each detail of the participant when the input data is received during the test including time taken to answer the question, time taken to complete the test, transit time from one subject to another, transit time from one question to another, and difficulty level of the question, and a connection means connecting the interface unit, the server, and the processor.

### CROSS-REFERENCE TO RELATED APPLICATIONS

This application is the U.S. national phase entry under 35 U.S.C. § 371 of International Application No. PCT/IN2016/050387, filed Nov. 5, 2016, entitled PREPARATION ASSESSMENT SYSTEM AND METHOD THEREOF, which in turn claims priority to and benefit of India Application No. 4242/MUM/2015, filed Nov. 6, 2015, the contents of which are incorporated herein by reference in their entirety for all purposes.

### FIELD OF THE INVENTION

The present invention relates to a system and a method to assess preparation level of a participant, more particularly, to the system and the method that provides overall feedback to the participant including time analysis, difficulty level of questions, and strategy of paper solving for any competitive or non-competitive assessment based on pre-determined data and participant input.

### BACKGROUND OF THE INVENTION

Computer-based, desktop application and/or online portals, standard test administering and evaluation systems are widely used for majority of skill, knowledge, and competitive assessments. However, preparatory steps towards these exams have been focused on providing coaching through online or class room mode with a manual or computer-based examination to evaluate preparation level of the participant. The manual or computer-based examination evaluation provides an output of score, a break-up of the subject/topic level, and a rank of the participant. Thus, the complete preparatory evaluation is focused on relative assessment.

Hence, there is a need of an improved systems and methods that overcomes one or more aforesaid issues.

### SUMMARY OF THE INVENTION

In an embodiment, the present invention provides a preparation assessment system for competitive and non-competitive exams, the system comprising an interface unit configured to receive an input data from a participant, the input data includes answer for a question, a server for storing the input data received from the participant and a pre-determined data, a processor for processing the input data received from the participant and corresponding pre-determined data to generate an optimum result to be displayed on the interface unit in a graphical format, the processor configured to capture each detail of the participant when the input data is received during the test including time taken to answer the question, time taken to complete the test, transit time from one subject to another, transit time from one question to another, and difficulty level of the question, and a connection means connecting the interface unit, the server, and the processor.

In another embodiment, the present invention provides a method for preparation assessment of competitive and non-competitive exams, the method comprising the steps of receiving participant details through an interface unit and creating login credentials, logging into the system, by the participant, through the interface unit once the participant credentials are verified, by a processor, allowing the participant to select the test based on choice of stream, chapter, and topic through the interface unit, processing, by the processor, the input data received from the participant during the test and corresponding pre-determined data stored on a server to generate an optimum result, and displaying the result in graphical format or other format based on choice of the participant on the interface unit, the result includes final score of the test, time taken to answer a question, difficulty level of the question, and expected time to answer the question.

### BRIEF DESCRIPTION OF DRAWINGS

s Reference will be made to embodiments of the invention, example of which may be illustrated in the accompanying figure(s). These figure(s) are intended to be illustrative, not limiting. Although the invention is generally described in the context of these embodiments, it should be understood that it is not intended to limit the scope of the invention to these particular embodiments.

FIG. 1 shows a preparation assessment system according to an embodiment of the present invention;

FIG. 2 shows a graphical representation of preparation assessment result on an interface unit according to an embodiment of the present invention;

FIG. 3 shows a graphical representation of preparation assessment result on an interface unit when a participant transit between the questions and subjects according to an embodiment of the present invention;

FIG. 4 show a graphical representation of preparation assessment result on an interface unit with a detailed overview of a particular question according to an embodiment of the present invention;

FIG. 5 shows an overview of preparation assessment result on an interface unit according to an embodiment of the present invention;

FIG. 6 shows a preparation assessment result with details of a particular test on an interface unit according to an embodiment of the present invention; and

FIG. 7 shows a preparation assessment result with details of a particular question on an interface unit according to an embodiment of the present invention.

### DETAILED DESCRIPTION OF THE INVENTION

Accordingly, in an embodiment, the present invention provides a preparation assessment system comprising an interface unit for receiving an input data from a participant, a server for storing the input data received from the participant and a pre-determined data, a processor for processing the input data received from the participant and the pre-determined data stored in the server to generate an optimum result, and a connection means connecting the interface unit, the server, and the processor.

According to the present invention, the interface unit comprises an input device for receiving participant input and display of the optimum result and a controller connected to the server and the processor through a connection means for sending and receiving of the data. The interface unit is configured to display the data stored in the server such as participant login, participant registration, competitive and non-competitive assessment etc. and receive the input data from the participant, the input data is stored in the server. The input device includes a monitor to view the data and a keyboard for input of the data. Additionally, the input device includes touch screen monitors, tablets, or other computing devices for input and display of the data.

According to the present invention, the interface unit is configured to receive the participant details and store the participant details on the server to create login credentials of the participant; once the login credentials of the participant has been created; the participant can login into the system and is able choose the test based on the choice of stream, chapter, topic, etc. that have been selected during registration by the participant. The stream, chapter, and topics are pre-determined data for competitive exams including academic and job oriented or non-competitive exams stored on the server for which the assessment or test can be taken by the participant. The pre-determined data can be saved in the server using the interface unit or optionally during configuration of the server. Additionally, the interface unit provides an administrator login for creation and modification of the pre-defined data and for monitoring and control of the system. Advantageously, the interface unit is configured to display the result generated from the processor in a visual graphical format or other format as selected by the participant.

According to the present invention, the login credential of the participant allows the participant to view the streams or subjects for which the participant has been authorized to take the assessment. The streams available to each participant for taking the assessment varies on choice of subjects taken either competitive or non-competitive during registration into the system. Advantageously, the participant can select more streams from the registration module for taking the assessment.

According to the present invention, the administrator login includes a master admin and various other administrators depending on the role. The master admin login allows the admin to completely control the entire system and can create login for other administrator having specific access to the system depending on their role and responsibility. For an example, the master admin can create a subject admin which can create and modify questions of a particular subject for which it has been authorized. Therefore, the subject admin can only create and modify questions within the subject that has been allocated and will not have access to other part of the system.

According to the present invention, the interface unit configured to display list of questions to the participant when the participant has opted for the assessment. All the questions can be displayed on a single page or one question is displayed on one page. When one question is displayed on one page, the participant may move to the next question after the previous question has been attempted or the participant has an option to move to next question without making an attempt to the question by selecting the desired question number from the list of questions displayed on the interface unit.

According to the present invention, the server is configured to store the pre-determined data and the input data received from the participant through the interface unit. The pre-determined data includes data related to question for various competitive and non-competitive assessment and related parameters such as difficulty level of the question, solution to the question, correct answer of the question, expert opinion on that subject or question such as expected time to solve the question, etc. The arrangement of the question can be in hierarchical structure such as subject, sub-subjects, and related questions. Further, the pre-determined data includes details that need to be captured for the participant such as participant registration and login details. The pre-determined data for participant registration and login is displayed on the interface unit and on receipt of the data the processor allows the participant to login into the system. Additionally, the pre-determined data includes past attempt of the assessment taken by the participant. Advantageously, the server is configured to store the participant IP address, participant history, etc. for login credentials, detailed analysis, or security enhancement.

According to the present invention, the processor is configured to process the input data received from the participant through the interface unit; verify the login credentials details of the participant and allow the participant to take the test based on the credentials saved on the server. Further, the processor processes the input data received from the participant and the corresponding pre-determined data saved on the server to generate the optimum result, the optimum result includes final score of the test, time taken to answer the question, difficulty level of the question, expected time which would be required to answer the question, etc. displayed on the interface unit in a visual graphical format or any other format based on the participant preferences. Advantageously, the processor is configured for optimized processing of real time data being input by the participant to generate fast result.

According to the present invention, the processor is configured to capture all data of the participant while taking the test or assessment such as time taken to answer a particular question, time taken to complete the test, transition time from one question to another, transition time from one subject to another, number of times the question has been referred, status of the question i.e. correct, incorrect, or not attempted. Once the data has been captured, the processor process the captured data of the participant and corresponding pre-determined data to generate the optimum result which may be displayed on the same view where said questions are provided. The corresponding pre-determined data comprises of the data relevant to a particular test, for an example, if the participant is appearing for a physics test, the corresponding data will include relevant data related to that question being shown in the participant test.

According to the present invention, the result of the test or assessment can be represented in a graphical format or other form as selected by the participant such as tabular representation of the data on the interface unit. When the participant selects graphical format of representation of the result, the processor displays the data in the semi-circular format, tabular format, or other visual format to clearly depict the data such as number of question, time taken to complete the test, time taken to answer the question, transition time between the questions, solutions to the questions, etc. The time displayed can be in seconds, minutes, or hours depending on the preference chosen by the participant during registration or while appearing for the test.

According to the present invention, the processor is further configured to compare the capture data with the corresponding pre-determined data to display the data such as time taken by the participant to solve the question along with the expected time to solve the question based on expert opinion to help the participant to devise an strategy while solving the question.

According to the present invention, the connection means is used for connecting the interface unit, the server, and the processor. Advantageously, the connection means may be a wired or a wireless connection.

For an example, a participant input the details into the preparation assessment system through an interface unit and login credentials are created. The participant logins into the system on entering the login credential. The participant is allowed to take a test based on choice of stream, chapter, topic, job oriented specific exam, academic exams, etc. which are pre-determined and stored on the server. Once the participant has selected the test; on answering the questions the participant input data is stored on the server and the processor processes the participant data and the corresponding pre-determined data that is already stored on the server to generate the optimum result. When the test is completed the results are displayed on the interface unit which may be in graphical format or other format based on choice of the participant.

The present invention also provides a method for preparation assessment of competitive and non-competitive exams, the method comprising the steps of (a) receiving participant details through an interface unit and creating login credentials; (b) logging into the system, by the participant, through the interface unit once the participant credentials are verified by the processor; (c) allowing the participant to select the test based on choice of stream, chapter, topic, etc. through the interface unit; (d) processing, by a processor, the input data received from the participant during the test and corresponding pre-determined data stored on a server to generate an optimum result; and (e) displaying the optimum result in graphical format or other format based on choice of the participant, on the interface unit, the result includes final score of the test, time taken to answer a question, difficulty level of the question, expected time to answer the question, etc.

According to the present invention, the process of the generating the optimum result by the processor includes processing of the input data received from the participant such as answer of the questions, various other related data captured by the processor when the participant is undertaking the test such as time taken to solve a question, transit time from one question to other question, transit time from one subject to other subject, time taken to complete the test, etc. and the pre-determined data.

According to the present invention, the process of displaying the result in the graphical format includes displaying the data is semi-circular form or other visual representation to clearly depict the data such final score of the test, time taken to answer the question, difficulty level of the question, expected time to answer the question and the like, which may be displayed on the same view where said questions are provided.

The subject matter is now described with reference to the drawings, wherein like reference numerals are used to refer to like elements throughout. In the following description, for purpose of explanation, numerous specific details are set forth in order to provide a thorough understanding of the claimed subject matter. It may be evident however, that such matter can be practiced with these specific details. In other instances, well-known structures as shown in diagram form in order to facilitate describing the invention.

Referring FIG. 1, shows a preparation assessment system (100) according to an embodiment of the present invention, the system (100) comprising an interface unit (110, 111, 112) for receiving input data from a participant, a server (130) for storing a pre-determined data and the input data received from the participant through the interface unit (110, 111, 112), a processor (120) for processing the pre-determined data and the input data received from the participant to generate an optimum result to be displayed on the interface unit (110, 111, 112), and a connection means (140) connecting the interface unit (110, 111, 112), the server (130), and the processor (120).

As shown in FIG. 1, the interface unit (110, 111, 112) is configured to receive the participant details and store the details on the server (130) to create login credentials of the participant; once the login credentials of the participant have been created; the participant can login into the system and is able choose the test based on the choice of stream, chapter, topic, etc. which are pre-determined stored on the server (130). Further, the interface unit (110, 111, 112) may display various competitive exams both academic and job oriented which is stored on the server (130) and are ready for the participant to take the test. Advantageously, the interface unit (110, 111, 112) is used to display the optimum result generated from the processor (120) in a visual graphical format or other format as selected by the participant.

As shown in FIG. 1, the server (130) is configured to store the pre-determined data and the input data received from the participant through the interface unit (110, 111, 112). The server (130) stores various data related to the participant and the subjects, competitive or non-competitive, for which the assessment can be taken by the participant. The data related to assessment can be structured in hierarchical form such as subject, sub-subject, and questions. Further, various other related data for assessment can be stored such as such as difficulty level of the questions, expected time to answer the questions based on expert opinion, interpretations levels, past attempts of the participants, etc. Advantageously, the server (130) is configured to store the participant IP address, etc. for login credentials, detailed analysis, or security enhancement.

As shown in FIG. 1, the processor (120) is configured to process the input data received from the participant through the interface unit (110, 111, 112); verify the login credentials details of the participant and allowing the participant to take the test based on the credentials saved on the server (130). Further, the processor (120) configured to process all the data received from the participant, various other related data captured by the processor when the participant is undertaking the test such as time taken to answer the question, time taken to complete the test, transit time from one question to other, etc. and the corresponding data which are pre-determined saved on the server (130) to generate the optimum result, the optimum result includes final score of the test, time taken to answer the question, difficulty level of the question, expected time which would be required to answer the question, etc. displayed on the interface unit (110, 111, 112) in a visual graphical format or any other display format as selected by the participant.

As shown in FIG. 1, the connection means (140) is used for connecting the interface unit (110, 111, 112), the server (130), and the processor (120). Advantageously, the connection means (140) may be a wired or a wireless connection.

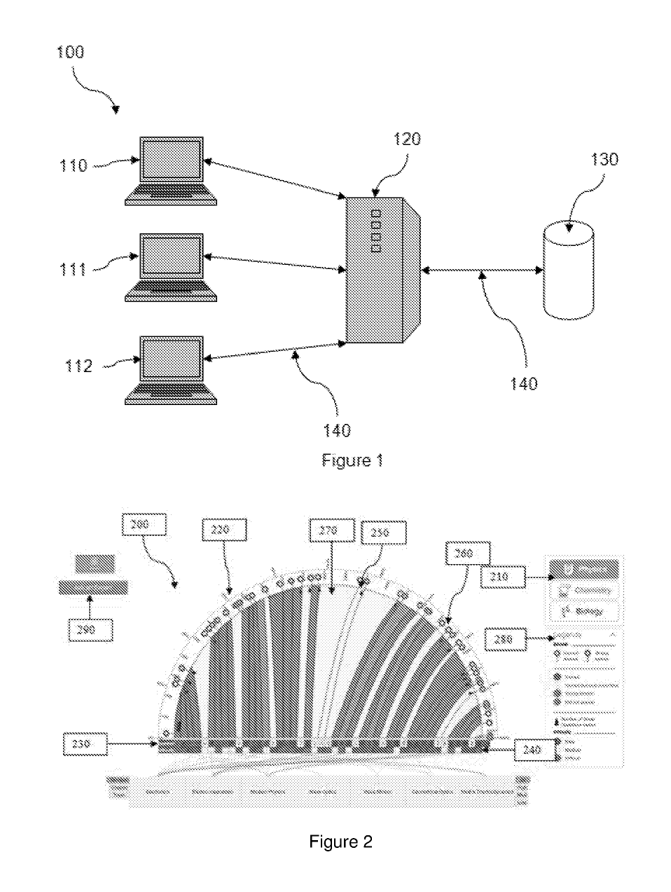

Referring FIG. 2 shows a graphical representation of preparation assessment result or report (200) on an interface unit according to an embodiment of the present invention. The preparation assessment report (200) is shown in two separate graphs, the first graph represents question of the test in semi-circular format and the other graph represent the details of subjects, legends, etc. The preparation assessment report (200) includes assessment subject (210) which can be changed, track of time (220) on the circumference of semicircle which is proportional to the time taken for a particular question. Each question is indicated at the base (230) along with the difficulty level (240) of each question represented by corresponding colours, where green colour indicates low difficulty, yellow indicates medium difficulty and red indicates high difficulty. The different colours used in the report indicate the preparation assessment parameters. The colour of the ribbon determines if the question was done right (green), right but in more time than acceptable (yellow), not-attempted(grey) or incorrect (red). Number of black triangles (250) indicates number of switches while width indicates the time taken in an attempt. Answers marked or submitted are indicated by pin (260) which is green if right and red in case wrong. Each question is linked to the track along the circumference depending on the time spent, the question is connected along with answers to form ribbon structures (270). Legends section (280) provides meaning of legend to help the user in understanding the graphical assessment. “Ask an Expert” (290) option is provided if the person viewing performance finds any difficulty in understanding the graphical assessment report.

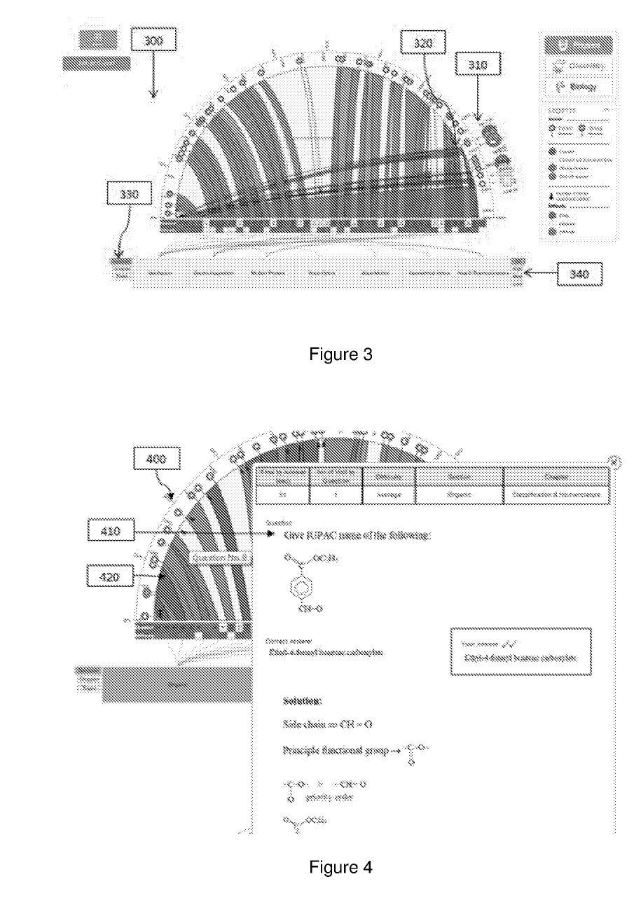

It shall be understood to a person skilled in the art that different colour combinations (red, green, grey, yellow) used for indicating the preparation assessment parameters may be altered without changing the scope of the present invention. These colour combinations are only for purpose of indication result of the preparation report and they can be changes as per the requirement. Referring FIG. 3 shows a graphical representation (300) of preparation assessment result or report on an interface unit when a participant transit between the questions and subjects according to an embodiment of the present invention. This graph provides details when the participant transit between the questions and the subjects while the participant is undertaking the test. The transit from one subject to other subject (310) is shown on the circumference of semi-circular graph. The transit time from a subject (310) is shown on both sides of the subject symbol i.e. upper time may represent the time when the subject was accessed and the below time may represent time when the subject was existed. The assessment report further represents the number of transit for the question (320), the transit is represented on the graph with the time spent on the question during particular transit of the question. The questions on the graph related to particular chapter or section is highlighted when section or chapter level (330) is selected or difficult questions are highlighted when difficulty level (340) is selected within a selected subject.

FIG. 4 show a graphical representation of preparation assessment result (400) on an interface unit with a detailed overview of a particular question which may be displayed on the same view where said questions are provided according to an embodiment of the present invention. The preparation assessment result (400) includes graphical representation of result with details of particular question (420). When the particular question (420) is selected on the graph or pointer is moved, the details (410) of the particular question (420) is shown. The details (410) of the particular question (420) includes question, answer, solution of the question and quantitative assessment of the preparedness which includes time to answer in seconds, number of visits to the question, difficulty level, section and chapter.

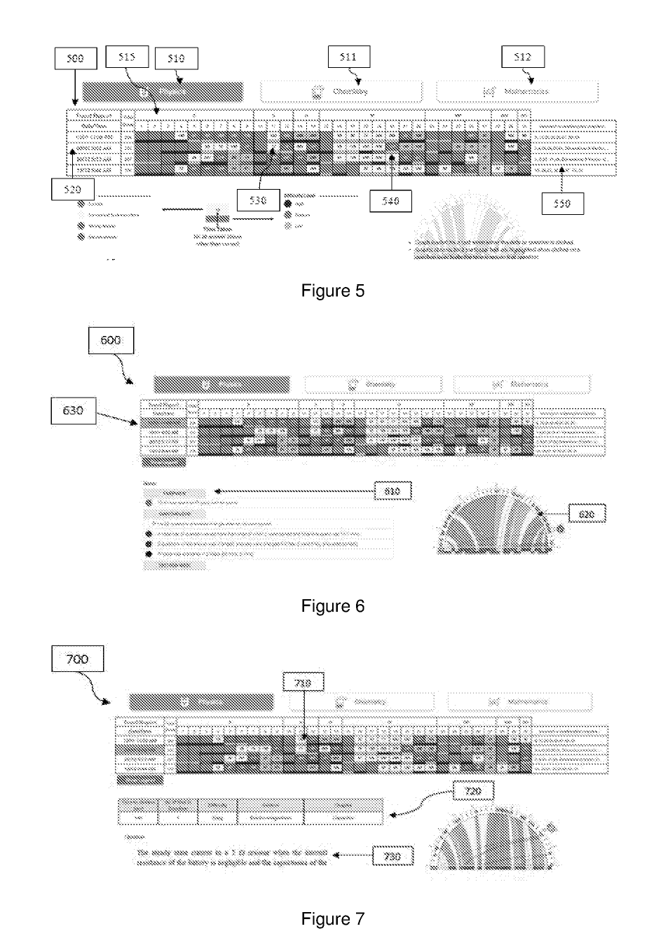

Referring FIG. 5 shows an overview of preparation assessment result (500) on an interface unit according to an embodiment of the present invention. The preparation assessment result (500) on interface unit includes subjects (510, 511, 512) of assessment, date (520) of assessment, time taken (530) for responding each question, difficulty level (540) of each question, chapters (550) to display the chapters of the sub-subject (515) for which questions were not attempted or answers were incorrect.

As shown in FIG. 5, the subjects (510, 511, and 512) of the assessment displays the list of all the subjects for which the assessment by the participant has been taken. The subjects (510, 511, and 512) includes a section (515) for which the assessment by the participant has been taken. Advantageously, the subjects (510, 511, and 512) may include multiple sections for which the assessment can be taken by the participant.

As shown in FIG. 5, the date (520) of the assessment displays all the dates on which the participant has taken assessment of a particular subject. The date (520) is displayed in descending order of test being attempted by the participant. This figure gives an indication to the participant about section performance across tests. Participant can adopt an appropriate change in preparation method based on whether the performance is improving or deteriorating.

As shown in FIG. 5, the time taken (530) is displayed in each question including representation for time taken to answer the question and status of the question i.e. the answer is correct, incorrect, or question is not attempted. The time taken (530) represents the time taken (in seconds) by the participant for solving questions of the assessment.

As shown in FIG. 5, the question of the assessment has the difficulty level (540) for displaying whether the level to solve the question is low, medium, or high. Each difficulty level (540) has a different colour for its representation. Advantageously, the difficulty level (540) is configurable by the administrator and multiple difficulty level (540) can be set for each question.

As shown in FIG. 5, the chapter (550) displays the list of the chapters of the sub-subject (515) for which questions were not attempted by the participant or the answers were incorrect. The chapter (550) provides an overview to the participant for chapter for which more preparation or focus has to be given.

Referring FIG. 6 shows a preparation assessment result (600) with details of a particular test on an interface unit according to an embodiment of the present invention. The preparation assessment report (600) includes a subject and the exams taken by the participant on a particular date with time. When a particular exam (630) is being clicked or a cursor is moved over it, the detailed analysis of particular exam (630) is shown up in overview section (610) and graphical section (620). The overview section (610) includes detail of total time spent during the assessment, number of question attempted, total number of correct and incorrect answers, performance in the level of difficulty of the question, etc. The graphical section (620) represents in detail the assessment taken by the participant of the particular date in the graphical form, it provides a quick overview of the assessment result to the participant.

Referring FIG. 7 shows a preparation assessment result (700) with details of a particular question on an interface unit according to an embodiment of the present invention. The detailed analysis of the particular question (710) is shown when clicked or cursor is moved over it. The detailed analysis of the particular question (710) includes quantitative assessment section (720) where time to answer in seconds, number of visits to the question, difficulty level, section and chapter are shown, and question and answer section (730) which displays the question and the solution. While the preparation assessment system and method described herein specification is locally stored on the computer system, it is understood that the system and the method is adaptable to the computer environment which can be accessed through remote server, cloud environment, etc.

The foregoing description of the invention has been set merely to illustrate the invention and is not intended to be limiting. Since modifications of the disclosed embodiments incorporating the substance of the invention may occur to person skilled in the art, the invention should be construed to include everything within the scope of the disclosure.

1. A preparation assessment system for competitive and non-competitive exams, the system comprising:
an interface unit configured to receive an input data from a participant, the input data includes answer for a question;
a server for storing the input data received from the participant and a pre-determined data;
a processor for processing the input data received from the participant and corresponding pre-determined data to generate an optimum result to be displayed on the interface unit in a graphical format, the processor configured to capture each detail of the participant when the input data is received during the test including time taken to answer the question, time taken to complete the test, transit time from one subject to another, transit time from one question to another, and difficulty level of the question;
a connection means connecting the interface unit, the server, and the processor;
wherein the server is configured to store the pre-determined data, the pre-determined data includes categories of subjects and related question, difficulty level of each question, solutions for the question, pre-determined ideal time to solve said questions, colour scheme to represent the difficulty level of the question, and
wherein the graphical format of the result represents detail data of the test taken by the participant, the detail data includes time taken to answer the particular question, difficulty level of the question, number of visits and respective instances to re-visit said questions, instances at which the participant provide answers to said questions, complete list of the question, time taken to complete the test, and transit time from one subject to another, and
wherein the detailed summary of the test or the question is shown, which may be displayed on the same view where said questions are provided, including time taken to complete the test, time taken to answer the question, number of visits and respective instances to re-visit said questions, instances at which the participant provide answers to said questions, and solution for the question upon receiving one or more inputs from said participant on a particular test section or a question displayed on the graphical format of the result.

2. The preparation assessment system as claimed in claim 1, wherein the interface unit configured to display the data fetched from the server, the fetch data includes details for registering new participant and questions based on the type of test opted by the participant either competitive or non-competitive or combination thereof.

3. The preparation assessment system as claimed in claim 1, wherein the server is configured to store the input data from the participant and data captured by the processor during the test including login credential of the participant, participant information detail, type of assessment opted by the participant, IP address, time taken to answer the question, time taken to complete the test, and transit time from one question to other.

4-6. (canceled)

7. A method for preparation assessment of competitive and non-competitive exams, the method comprising the steps of:
receiving participant details through an interface unit and creating login credentials;
logging into the system, by the participant, through the interface unit once the participant credentials are verified, by a processor;
allowing the participant to select the test based on choice of stream, chapter, and topic through the interface unit;
processing, by the processor, the input data received from the participant during the test and corresponding pre-determined data stored on a server to generate an optimum result, wherein the generating the optimum result includes processing of the input data received from the participant such as answer of the questions, various other related data captured by the processor when the participant is undertaking the test such as time taken to solve a question, transit time from one question to other question, transit time from one subject to other subject, and time taken to complete the test, and the pre-determined data; and
displaying the result in graphical format or other format based on choice of the participant on the interface unit which may be provided on the same view where said questions are provided, the result includes final score of the test, time taken to answer a question, difficulty level of the question, number of visits and respective instances to re-visit said questions, instances at which the participant provide answers to said questions and expected time to answer the question.

8. (canceled)

9. The method for preparation assessment as claimed in claim 7, wherein said displaying of the result in the graphical format, by providing the question level details on the same view where said questions are provided, includes displaying the data in semi-circular format or other visual representation to clearly depict the data such final score of the test, time taken to answer the question, difficulty level of the question, and expected time to answer the question.
